(19) United States
(12) Patent Application Publication
(10) Pub. No.: US 2010/0293392 A1
(43) Pub. Date: Nov. 18, 2010

(54) SEMICONDUCTOR DEVICE HAVING SECURE MEMORY CONTROLLER

(75) Inventor: Hisaya Miyamoto, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/714,791

(22) Filed: Mar. 1, 2010

(30) Foreign Application Priority Data
May 15, 2009 (JP) 2009-118909

(51) Int. Cl. G06F 12/14

(52) U.S. Cl. 713/193; 711/163; 711/E12.091; 711/E12.092

(57) ABSTRACT

A secure memory controller includes a memory unit and a controller. The memory unit stores the information of the predetermined scenario in accordance with an application to be executed. The controller gives the right to access the memory area based on the set scenario. The controller judges whether the bus master which is requesting an access to the memory area has the right to access.

### CROSS REFERENCE TO RELATED APPLICATION

This application is based upon and claims the benefit of priority from the prior Japanese Patent Application No. P2009-118909, filed on May 15, 2009, the entire contents of which are incorporated herein by reference.

### FIELD OF THE INVENTION

The present invention relates to a semiconductor device and specifically relates to a semiconductor device having a secure memory controller which manages accesses to a protection memory area according to a previously specified processing sequence.

DESCRIPTION OF THE BACKGROUND

Commercial digital contents include image contents which are stored in media such as DVDs and sold. Such digital contents are encrypted so as not to be easily replicated. The digital contents are increasingly being distributed by download services via the Internet as well as by the media.

The digital contents are processed by consumer electronic devices such as, for example, portable terminals, personal computers, and DVD recorders. Before replying the copy protected digital contents, the consumer electronic devices unlock the copy protection internally. Design of the consumer electronic devices needs to consider most the situation where a malicious attacker reveals information necessary for unlocking of copy protection. Implementing the tamper resistance which is the resistance to attack into the system within a rational range is one of the most important issues in development of consumer electronic devices.

For example, security adaptors are proposed. The security adaptors allow an external memory storage not having a function of encrypting information to deal with information to be protected. Japanese Patent Application Publication No. 4009315 discloses a security adaptor which takes into account an external memory storage but not a main memory.

In a general system, for replying the image contents, an application running on a CPU reads data of a part of copy-protected image contents from a DVD or the like and writes the read data in a main memory. The application then reads the copy-protected data from the main memory and requests a cryptography processing unit to decrypt the data. The application transfers the result of the decryption to a video and audio processing unit for playback processing. In the playback processing, the CPU is not permitted to access the internal resource of the cryptography processing unit. Moreover, the cryptography processing unit is not permitted to be provided with a debugging interface. By employing such a structure of the system, the copy-protected data can be protected from malicious attackers.

However, the aforementioned system includes a significant defect. If the CPU is made controllable by a malicious attacker, the system could be misused as a device removing copy protection. In recent years, professional tools which used to be used by only particular programmers, such as for example, in-circuit emulators (ICE), are readily available at lower cost through personal trading on the Internet. Accordingly, developers of the consumer electronic devices need to pay careful attention to the CPU security.

In order to ensure the CPU security, it is necessary to obfuscate instructions to be executed by CPUs or obfuscate data which has been decrypted and outputted to the main memory by the cryptography processing unit. As for the obfuscation of the decrypted data, there is no effective means other than re-encryption to protect the data.

In a versatile system, a cryptography processing circuit, which has functions to decrypt various protected audio or video contents, is able to access the main memory by itself. In the case of such a versatile system, the number of accesses to the main memory from components of the system tend to be increased, although the system configuration can be simplified. The total size of local memory incorporated in a semiconductor device can be therefore reduced, and the unit price of the semiconductor device can be prevented from increasing. However, re-encrypting the decrypted data by the cryptography processing unit before outputting the data to the main memory requires a dedicated cryptography processing circuit mounted on another processing block configured to process data. This will cause degradation of the data processing performance of the semiconductor device and increase in circuit size and power consumption. In the case of a semiconductor device demanded to have high performance and cost reduction and the like, the unlocked data is located and processed in the main memory, where the data cannot be protected when the CPU is made controllable by a malicious attacker.

### SUMMARY OF THE INVENTION

According to an aspect of the invention is provided a semiconductor device, comprising a secure memory controller managing accesses to write data in a memory or read the data from the memory, wherein the secure memory controller includes: a memory unit storing a previously specified processing sequence corresponding to an application program to be executed; and a controller setting a predetermined area of the memory as a protection area configured to be accessed in accordance with the processing sequence.

According to another aspect of the invention is provided a semiconductor device, comprising an ATA controller reading ciphertext data from a storage medium and writing the read ciphertext data in a memory; a cryptography processing unit reading the ciphertext data written in the memory, performing predetermined decryption processing to convert the read ciphertext data into plain text data, and writing the converted plain text data in the memory; a processing unit generating an information signal by performing predetermined decoding processing on the plain text data written in the memory; a CPU acquiring a memory area necessary for an application to be executed in the memory and setting a scenario; and a secure memory controller giving a right to access the memory to any one of the ATA controller, the cryptography processing unit, the processing unit, and the CPU based on the scenario.

### BRIEF DESCRIPTION OF THE DRAWINGS

FIG. 1 is a diagram showing a system configuration of a consumer electronic device according to a first embodiment of the present invention.

FIG. 2 is a diagram showing a configuration of semiconductor device according to the first embodiment of the present invention.

FIG. 3 is a diagram showing a configuration of a secure memory controller according to the first embodiment of the present invention.

FIG. 4 is a diagram showing scenario and protection area setting processing according to the first embodiment of the present invention.

FIG. 5 is a diagram showing content reading processing by an ATA controller according to the first embodiment of the present invention.

FIG. 6 is a diagram showing ciphertext data reading processing by a cryptography processing unit according to the first embodiment of the present invention.

FIG. 7 is a diagram showing plain text data writing processing by the cryptography processing unit according to the first embodiment of the present invention.

FIG. 8 is a diagram showing decoding processing by a video and audio processing unit according to the first embodiment of the present invention.

FIG. 9 is a diagram showing processing performed in the case of an access violation according to the first embodiment of the present invention.

FIG. 10 is a flowchart showing an example of a processing flow of access right management based on the scenario according to the first embodiment of the present invention.

### DETAILED DESCRIPTION OF THE INVENTION

Hereinafter, an embodiment of the present invention will be described with reference to the drawings.

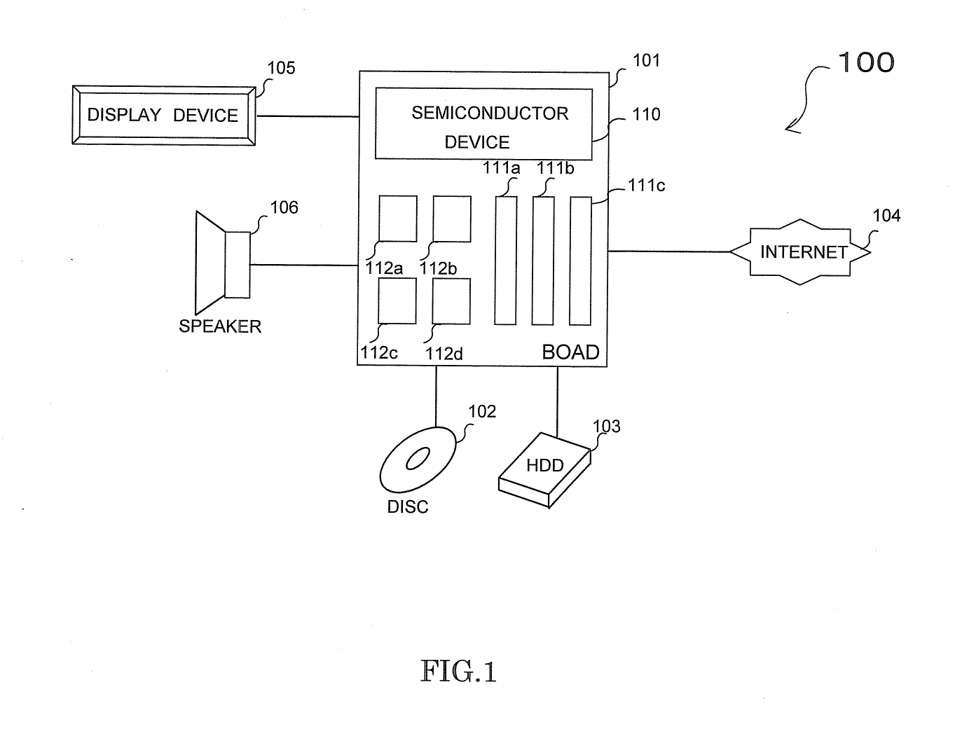

A semiconductor device according to the embodiment of the present invention will be described with reference to the drawings. FIG. 1 is a diagram showing a system configuration of a consumer electronic device. In the embodiment, the semiconductor device is provided with a secure memory controller, protecting a predetermined area of a memory.

As shown in FIG. 1, a consumer electronic device 100 includes a substrate 101, a DVD 102, an HDD 103, the Internet 104, a display device 105, and a speaker 106. Herein, the consumer electronic device 100 is a portable terminal but may also be a personal computer, a DVD recorder, or the like.

A semiconductor device 110, a plurality of advanced technology attachment (ATA) controllers 111a to 111c, and a plurality of memory devices 112a to 112d are mounted on the substrate 101. The semiconductor device 110 is a one-chip LSI. The plurality of memory devices 112a to 112d are used as a main memory.

The semiconductor device 110 reads encrypted data from the DVD 102 or HDD 103 through the ATA controller 111a or 111b, respectively. The encrypted data in this document means encrypted digital contents: video, audio, and so on. The semiconductor device 110 writes the read encrypted data in a memory area allocated in the memory devices 112a to 112d. The semiconductor device 110 reads the encrypted data downloaded from the Internet 104 through the ATA 111c. The semiconductor device 110 writes the read encrypted data in a memory area allocated in the memory devices 112a to 112d. The semiconductor device 110 reads the encrypted data written in the allocated memory area. The semiconductor device 110 performs predetermined decryption processing for the encrypted data and then writes the decrypted data in the same allocated memory area.

The DVD 102, HDD 103, and the Internet 104 are electronic media delivering information. In the following description, the encrypted data is ciphertext data, and the decrypted data is plain text data.

The semiconductor device 110 reads the data subjected to predetermined decryption processing from the memory area and performs the decoding processing for the read data to output the thus obtained image and sound signals to the display device 105 and the speaker 106, respectively. The consumer electronic device 100 performs playback processing of the digital contents read from, for example, the DVD 102.

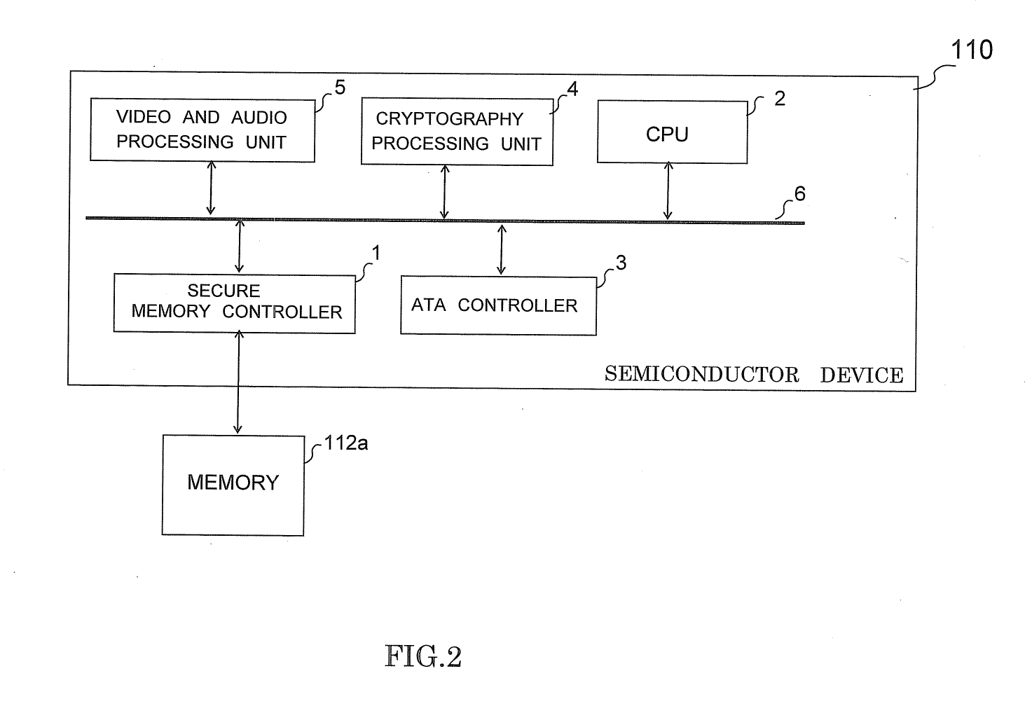

Next, the configuration of the semiconductor device 110 will be described in detail. FIG. 2 is a diagram showing a configuration of the semiconductor device 110.

As shown in FIG. 2, the semiconductor device 110 includes a secure memory controller 1, a CPU 2, an ATA controller 3, a cryptography processing unit 4, a video and audio processing unit 5, and a bus 6.

The secure memory controller 1, the CPU 2, the ATA controller 3, the cryptography processing unit 4, and the video and audio processing unit 5 are connected to each other via the bus 6. For clear explanation, herein, it is assumed that the secure memory controller 1 is connected to only the memory device 112a among the memory devices 112a to 112d (see FIG. 2). The following description is given based on FIG. 2 simplified.

The CPU 2 acquires a memory area necessary for an application to be executed in the memory 112a. The CPU 2 sets a scenario in the secure memory controller 1. The scenario is a description of a processing sequence actually executed using the system. The scenario stores the processing sequence corresponding to an application to be executed. When the application is executed, the right to access the allocated memory area is assigned to bus masters based on the scenario. The contents of the scenario are described in detail later.

The bus masters refer to processing blocks in the semiconductor device, which can access the memory 112a via the bus 6. In the embodiment, the CPU 2, the ATA controller 3, the cryptography processing unit 4, and the video and audio processing unit 5 correspond to the processing blocks. In the embodiment, the right to access the allocated memory area is assigned to any one of the CPU 2, the ATA controller 3, the cryptography processing unit 4, and the video and audio processing unit 5 based on the processing sequence included in a set scenario. The bus masters are assigned different identifiers (hereinafter, referred to as IDs). The accesses to the allocated memory area are controlled using the IDs. The allocated memory area is a protection-area accessible by only the bus master given the right to access based on the scenario.

The secure memory controller 1 controls writing of data in the memory 112a and reading of data from the memory 112a in response to the requests from the bus masters. Each bus master reads data to be processed from the memory 112a or writes data of results of processing in the memory 112a through the secure memory controller 1. The secure memory controller 1 controls accesses to the allocated memory area based on the scenario set by the CPU 2. The secure memory controller 1 performs control of giving the right to access to the allocated memory to any one of the CPU 2, the ATA controller 3, the cryptography processing unit 4, and the video and audio processing unit 5 based on the scenario.

The control of the right to access the memory 112a is implemented by a mechanism independent from the secure memory controller 1, for example, a memory protection unit (hereinafter, referred to as an MPU). The MPU manages the right to access a memory resource of a program executed by the CPU 2, for example, the memory 112a. The MPU is not dependent on the state or operation of the system at all. In the embodiment, the right of each bus master to access the protection area of the memory 112a is dynamically changed based on the state of the system, for example, the predetermined processing sequence.

The ATA controller 3 reads the ciphertext data from the DVD 102 or the like and writes the read ciphertext data in the allocated memory area of the memory 112a.

The cryptography processing unit 4 reads the written ciphertext data and performs the predetermined decryption processing to convert the read ciphertext data into the plain text data. The cryptography processing unit 4 writes the obtained plain text data in the memory area same as that where the ciphertext data has been stored.

The video and audio processing unit 5 reads the written plain text data and performs the predetermined decoding processing for the read plain text data to generate the image and sound signals. The video and audio processing unit 5 outputs the generated image and sound signals to the display device 105 and speaker 106, respectively. The encrypted digital contents stored in the DVD 102 can be thus replayed. The video and audio processing unit 5 functions as a processing unit performing playback processing of the encrypted digital contents.

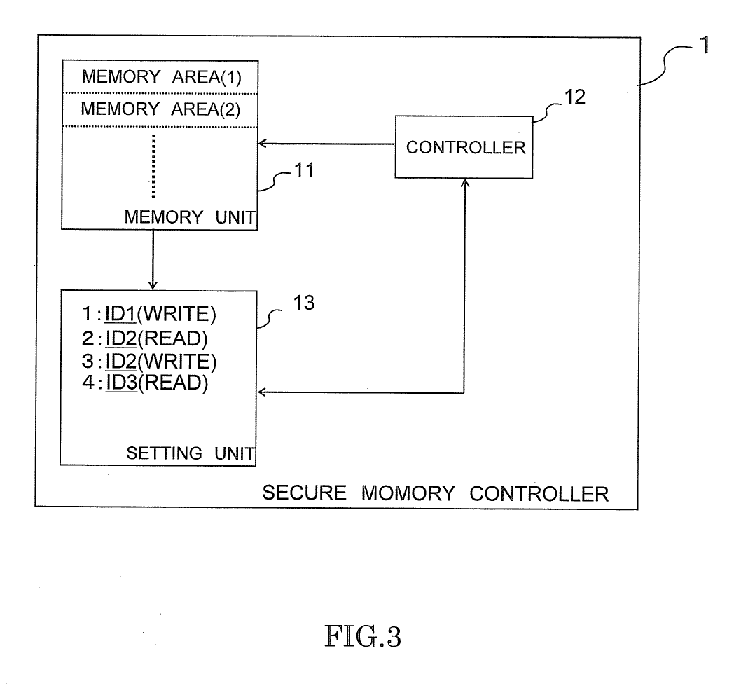

Next, the configuration of the secure memory controller 1 will be described in detail. FIG. 3 is a diagram showing the configuration of the secure memory controller 1.

As shown in FIG. 3, the secure memory controller 1 includes a memory unit 11, a controller 12, and a setting unit 13.

The memory unit 11 includes a plurality of memory areas. The first memory area stores information of the scenario for replying a DVD, for example. The second memory area stores the information of the scenario for replying downloaded contents, for example. The scenario includes data of the processing sequence corresponding to an application to be executed. The scenario varies depending on the application to be executed. If the scenario is structured in the secure memory controller 1 by hard wired means, the hardware cannot follow changes of the application. In order to follow changes of the applications, it may be configured so that the scenario can be set in the memory unit 11 of the secure memory controller 1, for example, via the bus 6 from the outside of the semiconductor device 110.

In the case of a secure system, applications to be executed are encrypted. In the case of a secure system, the CPU 2 usually performs authentication of the electronic signature to load an application to be executed. The CPU 2 requests the cryptography processing unit 4 to authenticate the electronic signature at loading an application. The CPU 2 registers a scenario corresponding to the application in the secure memory controller 1 when the authentication by the cryptography processing unit 4 is completed without problems.

The controller 12 reads a selected scenario from the memory unit 11 and registers the same in the setting unit 13 based on an instruction from the CPU 2.

The selected scenario is registered in the setting unit 13. FIG. 3 is an example where a scenario for DVD playback is set in the setting unit 13. The scenario provided in the setting unit 13 has a data structure of, for example, the number: device ID: right to access. The access right is any one of Read, Write, and Read and Write.

As shown in FIG. 3, when the scenario for DVD playback is selected, first in the setting unit 13, the ID of the ATA controller 3 (indicated by ID1) is set, and the access right of Write, that is, the right to write in the memory 112a is set. At the second in the setting unit 13, for example, the ID of the cryptography processing unit 4 (indicated by ID2) is set, and the access right of Read, that is, the right to read from, for example, the memory 112a is set. At the third in the setting unit 13, the ID of the cryptography processing unit 4 (indicated by ID3) is set, and the right to write in the memory 112a is set. At the fourth in the setting unit 13, the ID of the video and audio processing unit 5 (indicated by ID4) is set, and the right to read from the memory 112a is set.

The controller 12 gives the right to access the memory area based on the set scenario. The controller 12 judges whether the bus master which is requesting an access to the memory area has the right to access. At the judgment, the controller 12 compares the ID of the bus master having the right to access with the ID of the bus master which is requesting an access to the memory area based on the scenario. If judging based on the judgment result that the current access is requested by the bus master having the right to access, the controller 12 permits the access to the memory area. If judging that the current access is requested by the bus master not having the right to access, the controller 12 generates a bus error exception.

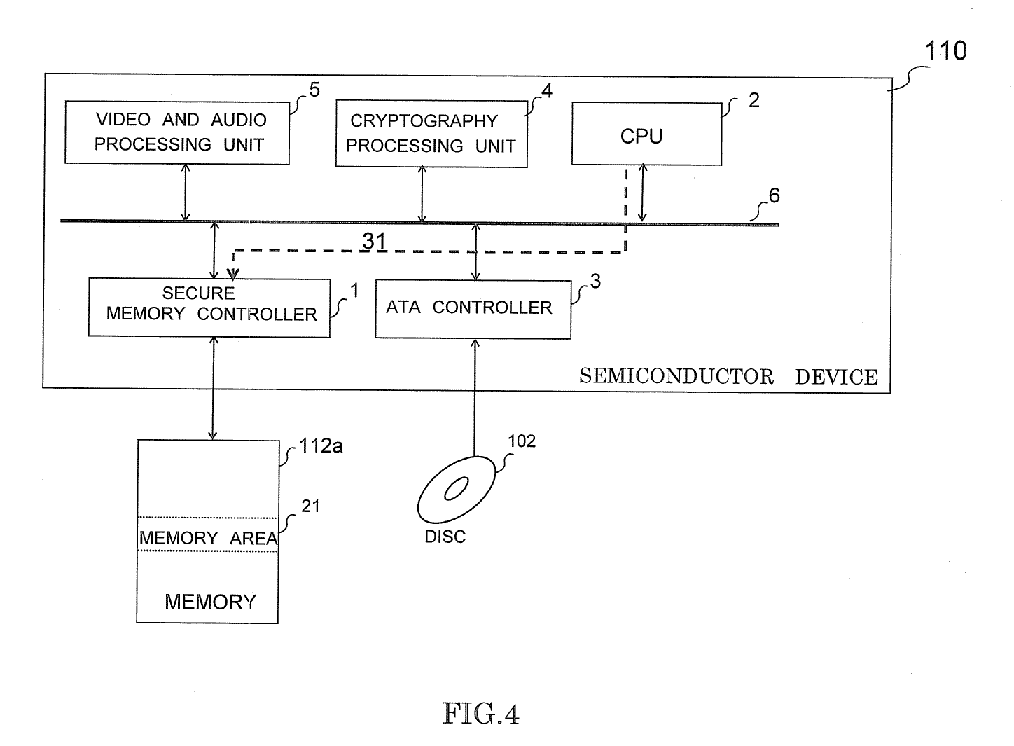

Next, using FIGS. 4 to 9, the flow of buffer management processing based on the scenario will be described. FIGS. 4 to 9 show the DVD playback processing as an example.

FIG. 4 is a diagram showing scenario and protection area setting processing. In the initial state, as indicated by a dashed arrow 31, the CPU 2 sets a scenario for DVD playback in the secure memory controller 1. The CPU 2 acquires a memory area 21 as a buffer area of a size necessary for the application to replay a DVD in the memory 112a. The CPU 2 specifies the size of data to be processed on the memory area 21 and sets by what kind of scenario the memory area 21 is to be managed.

The contents set in the secure memory controller 1 are information including the scenario for DVD playback which specifies a scenario to manage the memory area 21, the beginning address of the memory area 21, and the size of the memory area 21. By such setting, the memory area 21 having the specified size starting from the specified address is allocated in the memory 112a, and the first right to access to the memory area 21 is given to the ATA controller 3, which has the predetermined ID, based on the specified scenario.

For ease of explanation, one scenario is assumed to manage one protection area, but the number of protection areas managed by one scenario is not limited to one. A plurality of protection areas may be managed by one scenario. By managing the plurality of set protection areas based on one scenario, for example, the DVD playback processing can be smoothly executed. Herein, one scenario is set in the setting unit 13, but a plurality of scenarios may be set in the setting unit 13. By managing different protection areas through respective scenarios, different applications can be simultaneously executed based on the different scenarios.

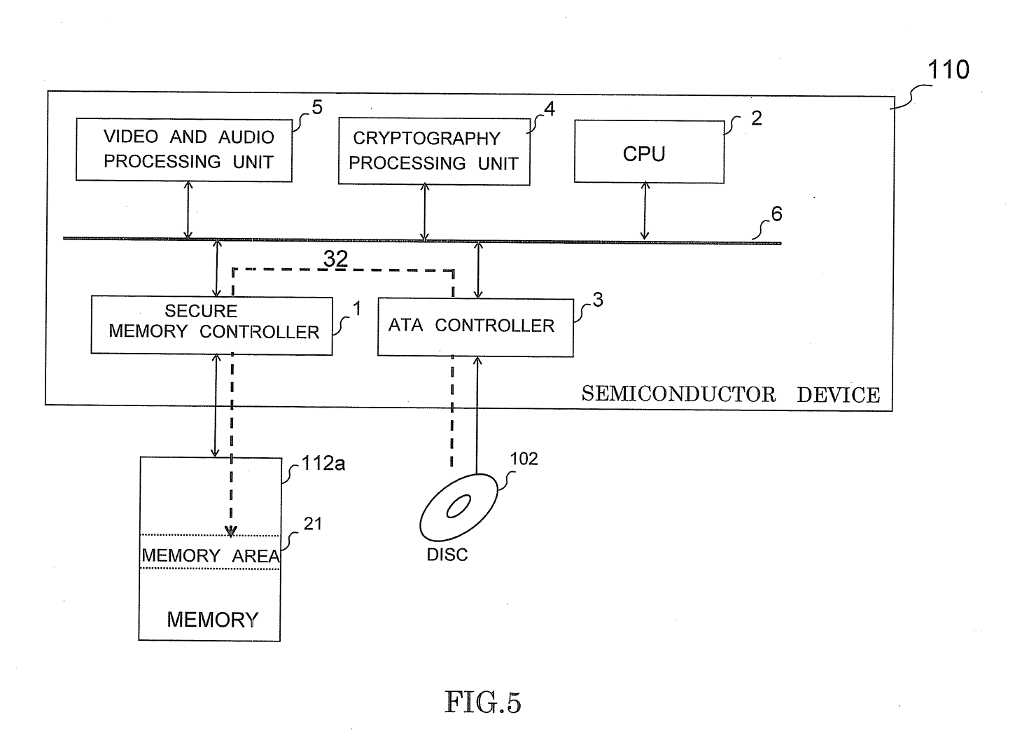

FIG. 5 shows a diagram showing content reading processing by the ATA controller. As indicated by a dashed arrow 32, the ATA controller 3 having the right to access loads encrypted data in the DVD 102 into the memory area 21 allocated in the memory 112a based on an instruction from the CPU 2. For example, a series of several packs of data read from the DVD 102 are loaded without being decrypted into the memory area 21 allocated in the memory 112a as the main memory. The secure memory controller 1 monitors the total amount of data written in the memory area 21, that is, transferred data. The secure memory controller 1 removes the right of the ATA controller 3 to access the memory area 21 when the total amount of data reaches a previously specified data size. Alternatively, the secure memory controller 1 detects the end of the transferred data and removes the right of the ATA controller 3 to access the memory area 21. The secure memory controller 1 delegates the right to access the memory area 21 to the cryptography processing unit 4 based on the scenario set in the setting unit 13.

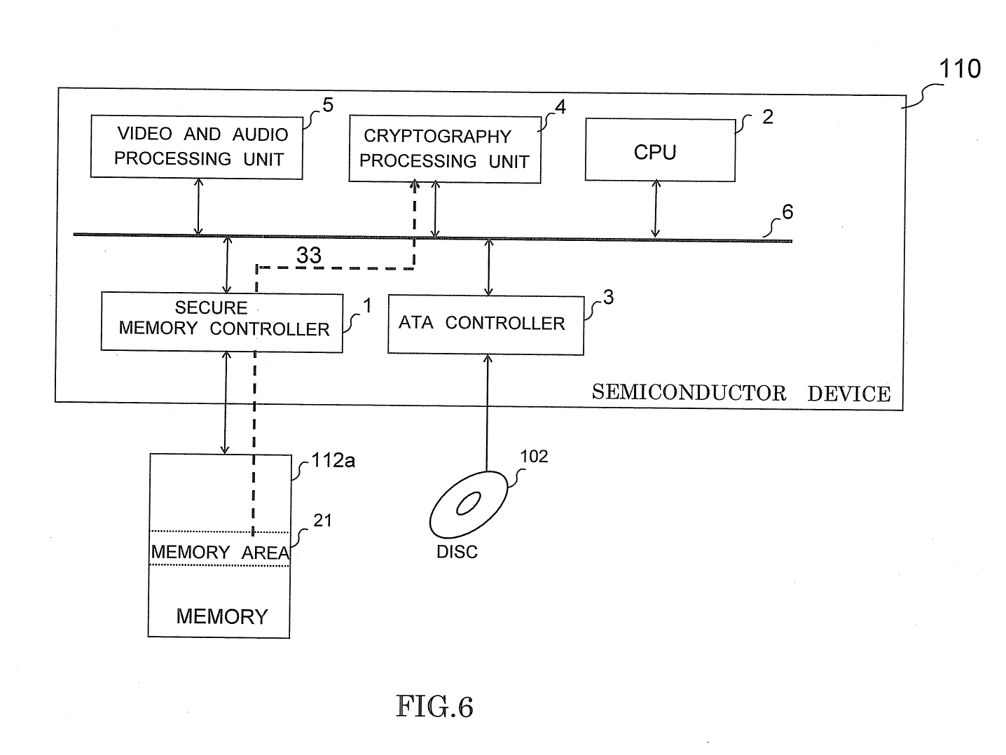

FIG. 6 is a diagram showing ciphertext data reading processing by the cryptography processing unit 4. As indicated by a dashed arrow 33, the cryptography processing unit 4 having the right to access reads the ciphertext data from the memory area 21 based on an instruction from the CPU 2. The cryptography processing unit 4 performs decryption processing according to a specified algorism to generate plain text data. The secure memory controller 1 monitors the total amount of data read from the memory area 21, that is, transferred data. When the total amount of data reaches a previously specified data size, the secure memory controller 1 removes the right of the cryptography processing unit 4 to access the memory area 21. Alternatively, the secure memory controller 1 detects the end of the transferred data and removes the right of the cryptography processing unit 4 to access the memory area 21. The secure memory controller 1 again transfers the right to access the memory area 21 to the cryptography processing unit 4 based on the scenario. In other words, upon completion of data transfer when the transfer of the data of the specified data size to the memory area 21 is completed by the cryptography processing unit 4, the right of the cryptography processing unit 4 to access the memory area 21 is once removed. Based on the scenario, the right to access the memory area 21 is again given to the cryptography processing unit 4.

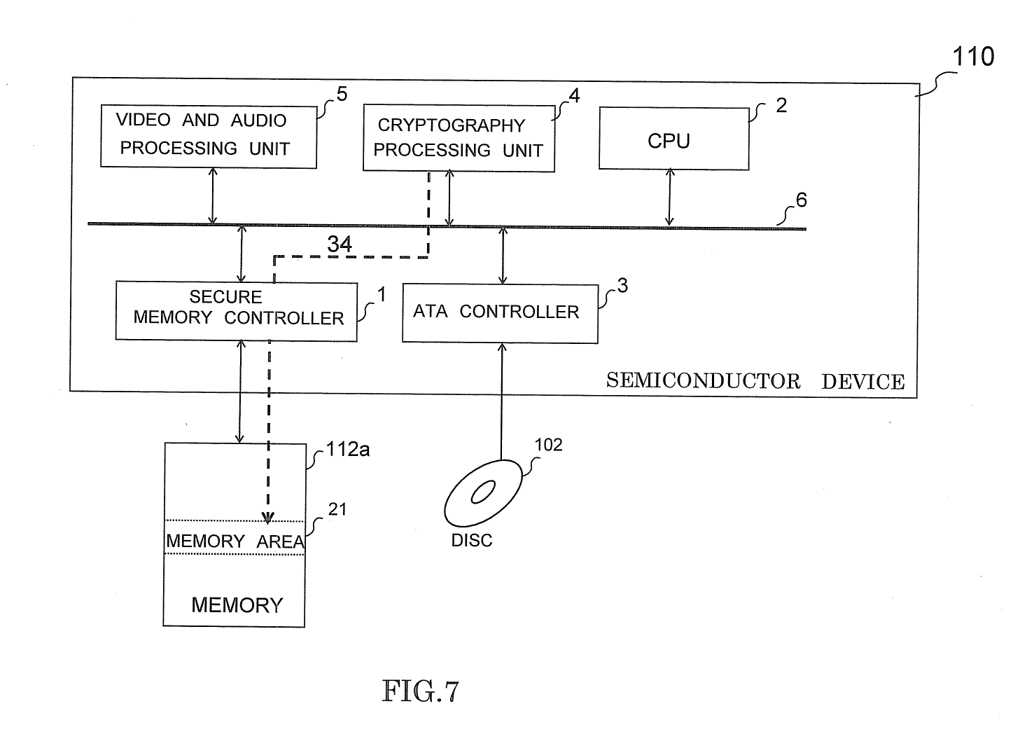

FIG. 7 is a diagram showing plain text data writing processing by the cryptography processing unit 4. As indicated by a dashed arrow 34, the cryptography processing unit 4 having the right to access writes the decrypted plain text data in the memory area 21 based on an instruction from the CPU 2. The secure memory controller 1 monitors the total amount of data written in the memory area 21. When the total amount of data reaches a previously specified data size, the secure memory controller 1 removes the right of the cryptography processing unit 4 to access the memory area 21. Alternatively, the secure memory controller 1 detects the end of the transferred data and removes the right of the cryptography processing unit 4 to access the memory area 21. The secure memory controller 1 transfers the right to access the memory area 21 to the video and audio processing unit 5 based on the scenario. In other words, upon completion of data transfer when the transfer of the data of the specified data size to the memory area 21 is completed by the cryptography processing unit 4, the right of the cryptography processing unit 4 to access the memory area 21 is removed. The right to access the memory area 21 is given to the video and audio processing unit 5.

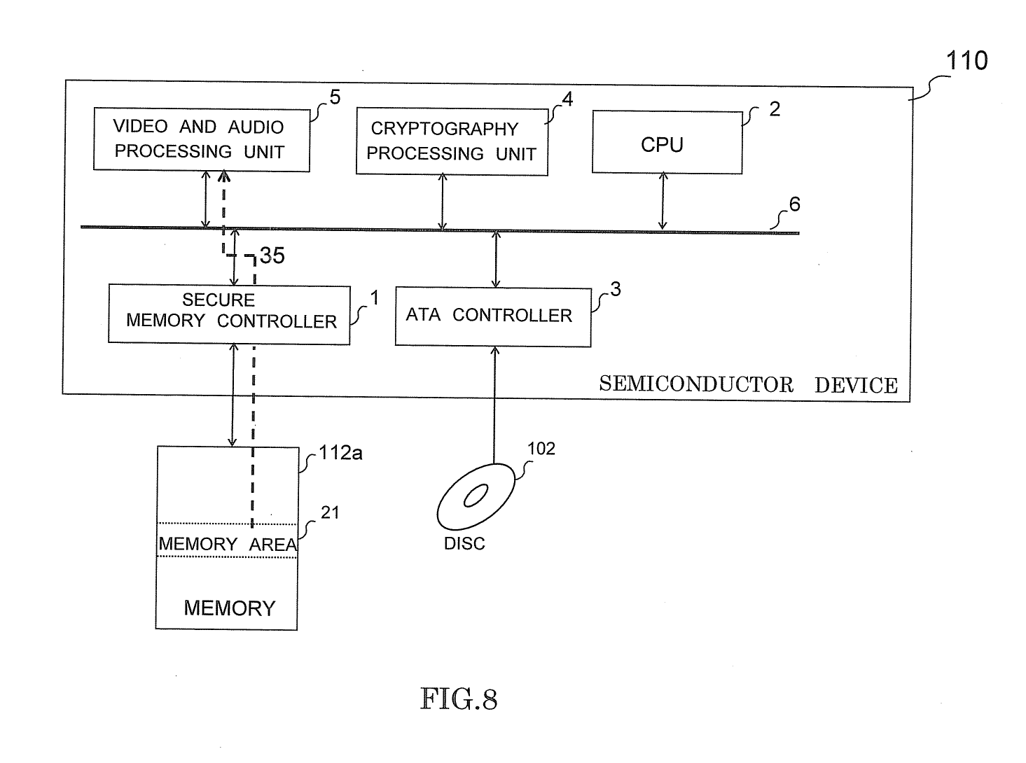

FIG. 8 is a diagram showing decoding processing by the video and audio processing unit 5. As indicated by a dashed arrow 35, the video and audio processing unit 5 having the right to access reads the plain text data from the memory area 21 based on an instruction from the CPU 2. The video and audio processing unit 5 performs decoding processing by the specified algorism and outputs the image and sound signals to the display device 105 and speaker 106, respectively. The secure memory controller 1 monitors the total amount of data read from the memory area 21. When the total amount of data reaches a previously specified data size, the secure memory controller 1 removes the right of the video and audio processing unit 5 to access the memory area 21. Alternatively, the secure memory controller 1 detects the end of the transferred data and removes the right of the video and audio processing unit 5 to access the memory area 21.

The secure memory controller 1 delegates the right to access the memory area 21 to the ATA controller 3 based on the scenario. In other words, when the transfer processing of the data of the specified data size by the video and audio processing unit 5 is completed, the right to access the memory area 21 is delegated from the video and audio processing unit 5 to the ATA controller 3.

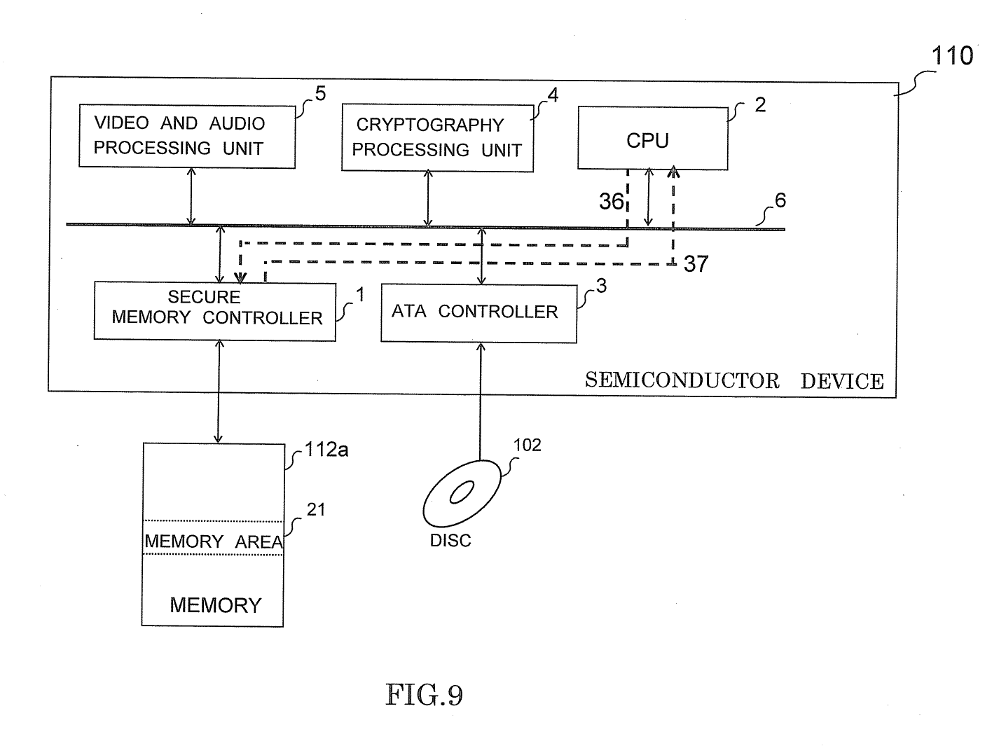

FIG. 9 is a diagram showing processing in the case of an access violation. Herein, as indicated by a dashed arrow 36, it is assumed that the CPU 2 not having the right to access the memory area 21 tries to read the plain text data of the memory area 21 while the video and audio processing unit 5 has the right to access the memory area 21. In this case, as indicated by a dashed arrow 37, the secure memory controller 1 detects a request to access the memory area 21 from the CPU 2 which is not permitted to access the memory area 21 in the set scenario. The secure memory controller 1 generates a bus error exception and stops the system. In such a manner, the secure memory controller 1 controls accesses of the bus masters to the memory area 21 based on the scenario of a particular application. The secure memory controller 1 therefore protects the plain text data on the memory area 21 of the memory 112a from malicious attacks in the system using the memory 112a located outside of the semiconductor device 110 without re-encryption.

During the DVD playback processing, the CPU 2 does not access data in the memory area 21 and does not have the right to access. The secure memory controller 1 gives the right to access to a particular bus master among the bus masters managed with different IDs under a certain condition based on the predetermined scenario for management of the accesses to the memory area 21. Accordingly, when the CPU 2, which does not have the right to access, tries to access the memory area 21, for example, the secure memory controller 1 generates a bus error exception and stops the system. To implement such a mechanism, the bus masters are managed with the different IDs.

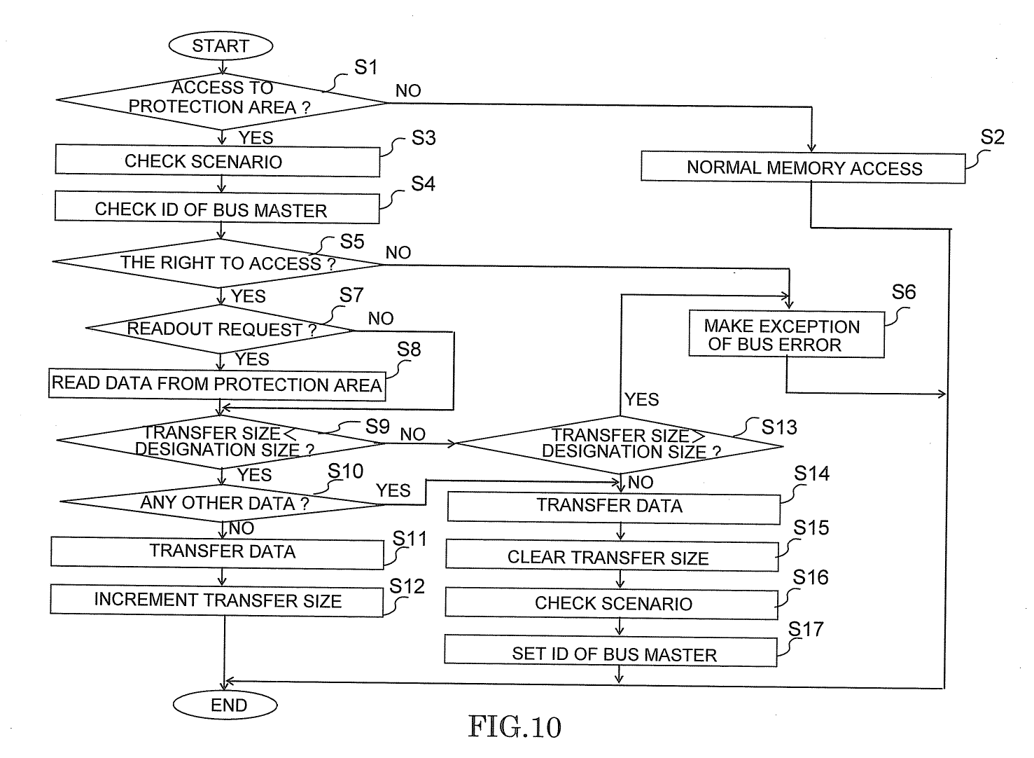

FIG. 10 is a flowchart showing an example of the flow of the right management processing based on the scenario. In the processing of FIG. 10, it is assumed that setting of the size of the memory area 21 and the like is already completed as setting of the scenario and protection area. At the completion of the setting, the “transfer size” managed within the secure memory controller 1 is cleared. The “transfer size” refers to a total amount of data that the bus master having a particular ID writes in a particular protection area or reads from a particular protection area. The “designation size” refers to a total amount of data that the bus master having a particular ID will write or read.

First, it is judged whether the requested memory access is an access to a set protection area (step S1). If the requested memory access is not an access to the set protection area, it is judged NO, writing or reading from the memory 112a as a normal access is executed, and then the processing is terminated (step S2). If the requested memory access is an access to the set protection area, it is judged YES, and the scenario set in the setting unit 13 is checked (step S3). The ID of the bus master which has requested for an access to the protection area is checked (step S4).

Next, it is judged whether the bus master having requested the access has the right to access (step S5). If the bus master does not have the right to access, it is judged NO. A bus error exception is generated, and the processing is terminated (step S6). On the other hand, if the bus master has the right to access, it is judged YES, and it is judged whether the requested access is a readout request (step S7). If the requested access is a readout request, it is judged YES, and data on the memory area 21 as the protection area is readout (step S8). If the requested access is not a readout request, it is judged NO, and the requested access is judged to be a write request. The processing then proceeds to step S9.

Subsequently, it is judged whether the transfer size is smaller than the designation size (step S9). If the transfer size is smaller than the designation size, it is judged YES, and it is judged whether the current pack of data transferred from the bus master or the data read from the protection area by the bus master is the end of the series of data (step S10). If the end of series of data is detected from the series of data transferred, it is judged YES, and the processing proceeds to step S14. If the end of series of data is not detected, it is judged NO, and the data is written in the memory 112a or the read data is transferred to the requesting bus master (step S11). The transfer size is then incremented (step S12).

On the other hand, if the transfer size is not smaller than the designation size in step S9, it is judged NO, and it is then judged whether the transfer size is larger than the designation size (step S13). If the transfer size is larger than the designation size, it is judged YES, and a bus error exception is generated in step S6. The processing is then terminated. In other words, if the transfer size is larger than the designation size, the processing is judged to be abnormal. A bus error exception is generated, and the processing in execution is terminated. If the transfer size is not larger than designation size, it is judged NO, and the processing proceeds to step S14. In other words, it is judged based on the judgment results of the steps S9 and S13 that the transfer size is equal to the designation size.

On the other hand, if it is judged in step S10 that the current pack of data is the end of the series of data or if it is judged in step S13 that the transfer size is equal to the designation size, the data is written in the memory 112a or the read data is transferred to the requesting bus master (step S14). The transfer size is then cleared (step S15). The scenario set in the setting unit 13 is checked (step S16). Eventually, based on the checked scenario, the bus master ID which will have the right to access next is set, and the processing is terminated (step S17).

By the above processing, the scenario corresponding to an application to be executed by the CPU 2 and the memory area 21 necessary for the application are set in the secure memory controller 1. The secure memory controller 1 gives the right to access the memory area 21 to any one of the bus masters based on the set scenario for controlling accesses to the memory area 21.

When a bus master other than the bus master having the right to access requests an access to the memory area 21, the secure memory controller 1 does not permit the access and generates a bus error exception. In the system using the memory 112a provided outside of the semiconductor device 110, the plain text data stored in the memory area 21 of the memory 112a can be protected from malicious attackers without being re-encrypted.

According to the secure memory controller of the embodiment, even if the CPU 2 is made controllable by a malicious attacker, the predetermined area of the memory can be protected. For example, it is possible to prevent malicious attackers who connect the CPU 2 of the consumer electronic device 100 to an in-circuit emulator (ICE) from copying high-quality image information contents stored in the DVD 102 and the like or producing pirated products and the like.

In the consumer electronic device 100 thus configured, by implementing the mechanism of protecting the plain text data stored in the memory 112a outside of the semiconductor device 110 based on the processing scenario, it is possible to realize a highly tamper-resistant system having a large memory capacity and not relying on embedded memory at comparatively low cost.

As for the steps of the flowchart in the specification, it is possible to change the order of the steps to execute some of the steps at the same time or execute the steps in different order at each execution without violating the nature.

The present invention is not limited to the aforementioned embodiment, and various changes, modifications, and the like can be made without departing from the spirit of the invention.

In the embodiment, the semiconductor device 110 is composed of a one-chip LSI but is not necessarily limited to the one-chip LSI. For example, the semiconductor device 110 may be composed of a plurality of ICs or may be composed of some modules.

What is claimed is:

1. A semiconductor device comprising a secure memory controller managing accesses to write data in a memory or read the data from the memory, wherein
the secure memory controller includes:
a memory unit storing a previously specified processing sequence corresponding to an application program to be executed; and
a controller setting a predetermined area of the memory as a protection area configured to be accessed in accordance with the processing sequence.

2. The semiconductor device according to claim 1, wherein
the controller manages, on the basis of the previously specified processing sequence, a right to access the protection area for each of a plurality of processing blocks that access the protection area.

3. The semiconductor device according to claim 1, further comprising:
a setting unit setting identifiers of the plurality of processing blocks to be given the right to access based on the processing sequence.

4. The semiconductor device according to claim 3, wherein
the plurality of processing blocks that access the protection area are managed with different identifiers, and
the controller compares the identifier of the processing block requesting the access and the identifier of the processing block given the right to access based on the processing sequence and judges whether or not to permit the access by the requesting processing block.

5. The semiconductor device according to claim 4, wherein
when the access of the processing block is judged to be not permitted based on a result of the judgment, the controller generates an exception.

6. The semiconductor device according to claim 1, wherein
when a plurality of the application programs to be executed exist, the memory unit stores the processing sequence corresponding to each of the application programs.

7. A semiconductor device, comprising:
an ATA controller reading ciphertext data from a storage medium and writing the read ciphertext data in a memory;
a cryptography processing unit reading the ciphertext data written in the memory, performing predetermined decryption processing to convert the read ciphertext data into plain text data, and writing the converted plain text data in the memory;
a processing unit generating an information signal by performing predetermined decoding processing on the plain text data written in the memory;
a CPU acquiring a memory area necessary for an application to be executed in the memory and setting a scenario; and
a secure memory controller giving a right to access the memory to any one of the ATA controller, the cryptography processing unit, the processing unit, and the CPU based on the scenario.

8. The semiconductor device according to claim 7, wherein
the ATA controller, the cryptography processing unit, the processing unit, the CPU, and the secure memory controller are connected to each other through a bus.

9. The semiconductor device according to claim 7, wherein
the right to access is given via the bus.

10. The semiconductor device according to claim 7, wherein
the ATA controller, the cryptography processing unit, the processing unit, and the CPU are assigned with different identifiers.

11. The semiconductor device according to claim 7, wherein
the read ciphertext data and the converted plain text data are written in a same memory area of the memory.

12. The semiconductor device according to claim 7, wherein
the secure memory controller includes:
a memory unit storing a previously specified processing sequence corresponding to an application program to be executed;
a controller setting a predetermined area of the memory to a protection area configured to be accessed in accordance with the processing sequence; and
a setting unit setting identifiers of the ATA controller, the cryptography processing unit, the processing unit, and the CPU to be given a right to access based on the processing sequence.

13. The semiconductor device according to claim 7, wherein
the storage medium outputs a digital content as the ciphertext data.

14. The semiconductor device according to claim 13, wherein the digital content is encrypted image or sound information.
